(19) United States
(12) Patent Application Publication
(10) Pub. No.: US 2015/0127574 A1
(43) Pub. Date: May 7, 2015

(54) TERMS OF SERVICE (TOS) AGREEMENT GENERATION METHOD AND ELECTRONIC DOCUMENT ENROLLMENT VERIFICATION METHOD WITHIN AN ONLINE SYSTEM

(71) Applicant: DigitalMailer, Inc., Herndon, VA (US)

(72) Inventors: Ronald M. DALY, JR., Centreville, VA (US); Leonard GIAMBALVO, Fort Mill, SC (US)

(73) Assignee: DigitalMailer, Inc., Herndon, VA (US)

(21) Appl. No.: 14/074,127

(22) Filed: Nov. 7, 2013

(51) Int. Cl. G06Q 10/10

(52) U.S. Cl. CPC G06Q 10/10
USPC 705/342

(57) ABSTRACT

A system and method for generating a terms of service agreement within an online document retrieval and storage system, and an electronic document enrollment verification process within the terms of service agreement that includes accessing the online document retrieval and storage system, viewing a terms of service (TOS) agreement displayed via the user computing device, selecting to view an electronic document within the TOS agreement, inputting verification information displayed within the electronic document, and accepting or rejecting the TOS agreement displayed.

### BACKGROUND OF THE INVENTION

1. Field of the Invention

The present invention relates to an electronic document enrollment verification method within an online system (e.g., an online banking system). More particularly, the present invention relates to an E-document enrollment verification system for verifying a user's ability to receive and view documents electronically.

2. Description of the Related Art

Today, consumers are conducting business online via a network (e.g., the Internet) instead of in-person or by mail. In order to conduct business online, an online system (e.g., online banking system) typically requires a user to complete a registration process enabling them access to their respective accounts via the online system. The registration process may include completion of a user profile including identification information (e.g., user's contact information, user name and password information). The user may be required to view and agree to system-specific terms and conditions prior to completion of the registration process for the online system. Further, a user may optionally select to receive correspondences concerning their accounts electronically instead of by mail. If the user selects to receive documents electronically, the user is required to grant consent to use of electronic documents and may be required to confirm his/her consent electronically.

One problem associated with existing online systems includes the inability to verify whether a user is capable of receiving and viewing documents electronically.

### SUMMARY OF THE INVENTION

The present invention obviates the above-mentioned issue by providing an electronic document enrollment verification system and method for verifying a user's ability to receive and view electronic documents.

According to one or more embodiments, the present invention provides a system and method for generating a terms of service agreement within an online document retrieval and storage system.

According to one or more embodiments, an electronic document enrollment verification process is performed by a user when viewing the terms of service agreement and includes accessing the online document retrieval and storage system, viewing a terms of service (TOS) agreement displayed via the user computing device, selecting to view an electronic document within the TOS agreement, inputting verification information displayed within the electronic document, and accepting or rejecting the TOS agreement displayed.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto, wherein in the following brief description of the drawings:

FIG. 1 is a block diagram of an online document retrieval and storage system (e.g., online banking system) for performing an enrollment verification process to be implemented within one or more embodiments.

FIG. 2 is a block diagram of an exemplary computer to be implemented within one or more embodiments of the present invention.

FIG. 3 is a flowchart illustrating a method for configuring terms of services (TOS) to be displayed via the online document retrieval and storage system of FIG. 1 to be implemented within one or more embodiments of the present invention.

FIG. 4 is a screenshot for viewing TOS settings, to be implemented within one or more embodiments of the present invention.

FIG. 5 is a screenshot of a process of creating TOS, to be implemented within one or more embodiments of the present invention.

FIG. 6 is a screenshot of a process for creating a Rejection Message for rejecting the TOS, to be implemented within one or more embodiments of the present invention.

FIG. 7 is a screenshot of a process for creating a Completion message for completing the TOS, to be implemented within one or more embodiments of the present invention.

FIG. 8 is a screenshot of a process for creating a statement to be viewed within the TOS, to be implemented within one or more embodiments of the present invention.

FIG. 9 is a screenshot of a process for uploading an electronic document to be viewed within the TOS, to be implemented within one or more embodiments.

FIG. 10 is a flowchart of an electronic document enrollment verification process to be performed by a user within the system of FIG. 1, to be implemented within one or more embodiments of the present invention.

FIG. 11 is a screenshot of TOS to be viewed by the user in accordance with one or more embodiments of the present invention.

FIG. 12 is a screenshot of an electronic document enrollment verification process to be implemented within one or more embodiments of the present invention.

FIG. 13 is a screenshot of an electronic document to be implemented within one or more embodiments of the present invention.

FIG. 14 is a screenshot of completion of the electronic document enrollment verification process that can be implemented within one or more embodiments of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

Specific details are given in the following description to provide a thorough understanding of the embodiments. However, it will be understood by one of ordinary skill in the art that the embodiments may be practiced without these specific details. For example, systems, networks, processes, and other components may be shown as components in block diagram form in order not to obscure the embodiments in unnecessary detail. Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

The present invention as will be described in greater detail below provides an educational guide module and method, and a method for a reward system within the virtual storage system. The present invention provides various embodiments as described below. However it should be noted that the present invention is not limited to the embodiments described herein, but could extend to other embodiments as would be known or as would become known to those skilled in the art.

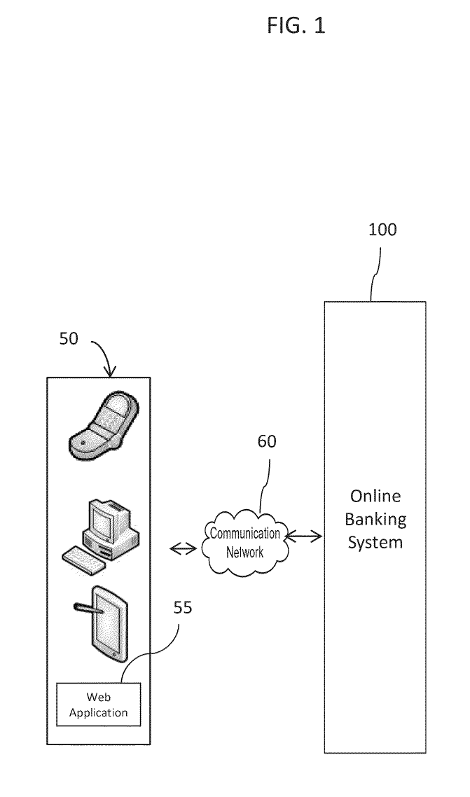

FIG. 1 is a block diagram of an online document retrieval and storage system that can implemented within one or more embodiments of the present invention. In FIG. 1, a user at a user computing device 50 is configured to access, via a communication network 60, an external system i.e., an online document retrieval and storage system such as an online banking system 100, to perform online banking transactions, such as viewing bank accounts and bank statements, applying for loans, and other transactions. According to one or more embodiments, the user computing device 50 includes at least one of a mobile phone or smart phone, a personal computer or laptop, a personal digital assistant (PDA), or tablet. The present invention is not limited to any particular type of user computing device 50, and may vary accordingly.

The user accesses the online banking system 100 by inputting input data including identification and log-in information such as a user ID and password via a user interface (UI) of the user computing device 50. Once the identification/log-in information is received at a banking application of the online banking system 100, the online banking system 100 retrieves the user's banking information and displays the banking information via a display of the user computing device 50. The online banking system 100 is configured to receive the input data and provide the user with electronic documents (e.g., bank statements) in webpage format or any other format over the communication network 60. According to one or more embodiments, the banking application may include a Terms of Service (TOS) agreement outlining the terms of use of the online banking system 100. The TOS agreement may further include authorization to receive documents electronically within the online banking system 100. The user may be required to complete an electronic document enrollment verification process in order to begin use of the online banking system 100.

The communication network 60 includes a wired or wireless network for data communication. The data communication across the communication network 60 is achieved by using web services technology including for example, Web services Description Language (WSDL). The communication network 60 may include any subsystem for exchanging data such as the Internet, intranet, extranet, wide area network (WAN), local area network (LAN), Restful web services, JAVAScript Object Notation (JSON), Extensible Mark-up Language (XML)-based communication network, Simple Object Access Protocol (SOAP)-based Services and satellite communication network. Further, the communication network 60 can be another type of network such as interactive television (ITV).

The user computing device 50 may include a web application 55 for providing a secure connection between the user computing device 50 and the online banking system 100. The web application 55 is an internet-enabled application, for example, that has specific functionality for the user computing device 50 (e.g., a mobile phone). The web application 55 is accessed through a web browser of the user computing device 50 and does not require downloading and installing thereof onto the user computing device 50.

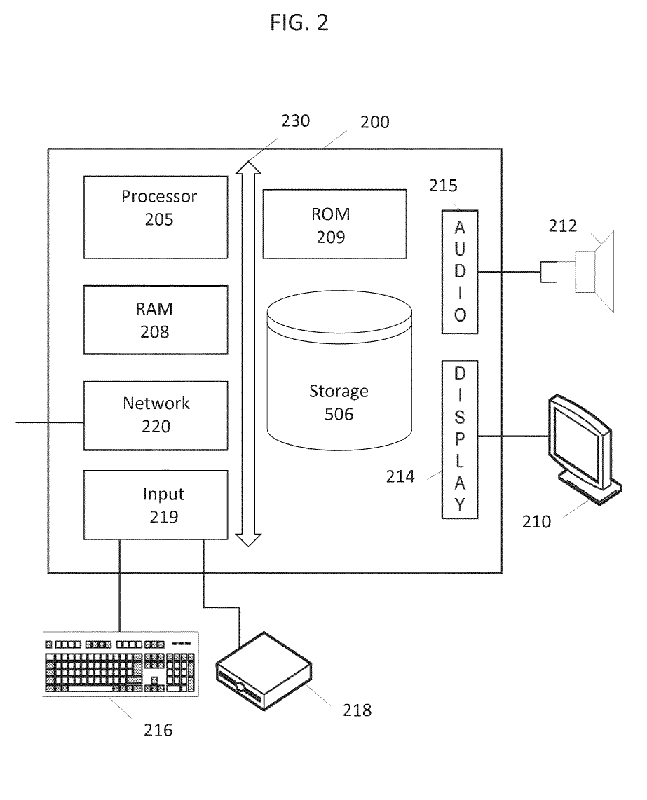

FIG. 2 is a block diagram of an exemplary computing device 200 illustrating components of the user computing device 50 and the online banking system 100. As shown in FIG. 2, the computing device 200 includes various components for inputting, outputting, storing and processing data. The computing device 200 includes a processor 205 for performing tasks including executing one or more applications, retrieving data from a storage device e.g., storage 206, and/or outputting data. The processor 205 can be connected to a

Random access memory (RAM) module 208 wherein application data and/or instructions may be temporarily stored. The computing device 200 can further includes a Read Only Memory (ROM) 209 configured to allow data stored thereon to persist after the computing device 200 is turned off and is used for storing an operating system (OS) of the computing device 200. The storage device 206 may also provide storage for data files and may include computer readable mediums e.g., disk drives, optical storage mediums e.g., CD ROM drives, magnetic tape storage systems, and flash memory. The processor 205 is configured to retrieve an application from the storage 206 and store the instructions associated with the application in the RAM module 208, while the processor 205 is executing the application. The computing device 200 further includes output devices e.g., a display device 210, and a speaker 212, for outputting visual and audio data via a display adapter 214 and an audio adapter 215. Further, the computing device 200 includes input devices e.g., a keyboard 216, a storage media drive 218, and microphone each having an associated adapter 219 for converting the input data into computer readable data. The storage media drive 218 enables users to read and write data to and from the storage media.

Further, as shown, the user computing device 50 includes one or more components for receiving and transmitting data over the communication network 60. For example, a network adapter 220 is provided for communication with one or more computing devices over an IP network, for example, for transmission of data such as financial data over the online banking system 100. The network adapter 220 may include instructions associated with processing IP network packets and cellular network packets. The components of the computing device 200 are connected via a system bus 230.

According to an embodiment of the present invention, set up and management of the TOS agreement to be displayed to the user in the banking application, may be set up at the online banking system 100 via an authorized party of the online banking system 100. The authorized party is able to create, edit, delete and setup a default TOS agreement as needed.

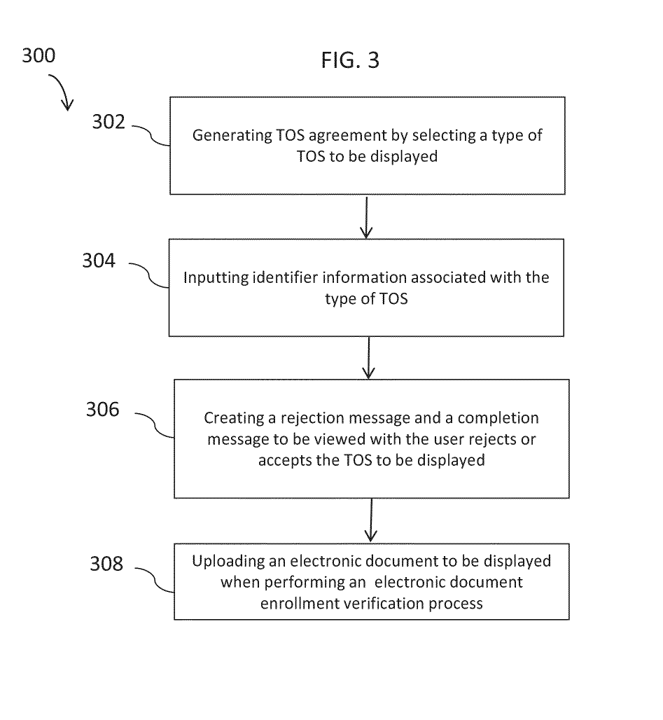

FIG. 3 is a flowchart illustrating a method 300 for generating a TOS agreement to be displayed. The TOS agreement to be generated may further include an electronic document enrollment verification process to e-sign compliance in accordance with specific rules and regulations within the banking industry. The electronic document enrollment verification process may be implemented separately or as a part of the banking application when establishing account access by a user. The electronic document enrollment verification process determines whether a user is able to receive and view documents, electronically. The method 300 is implemented in software modules for execution by the user computing device 50 and the online banking system 100.

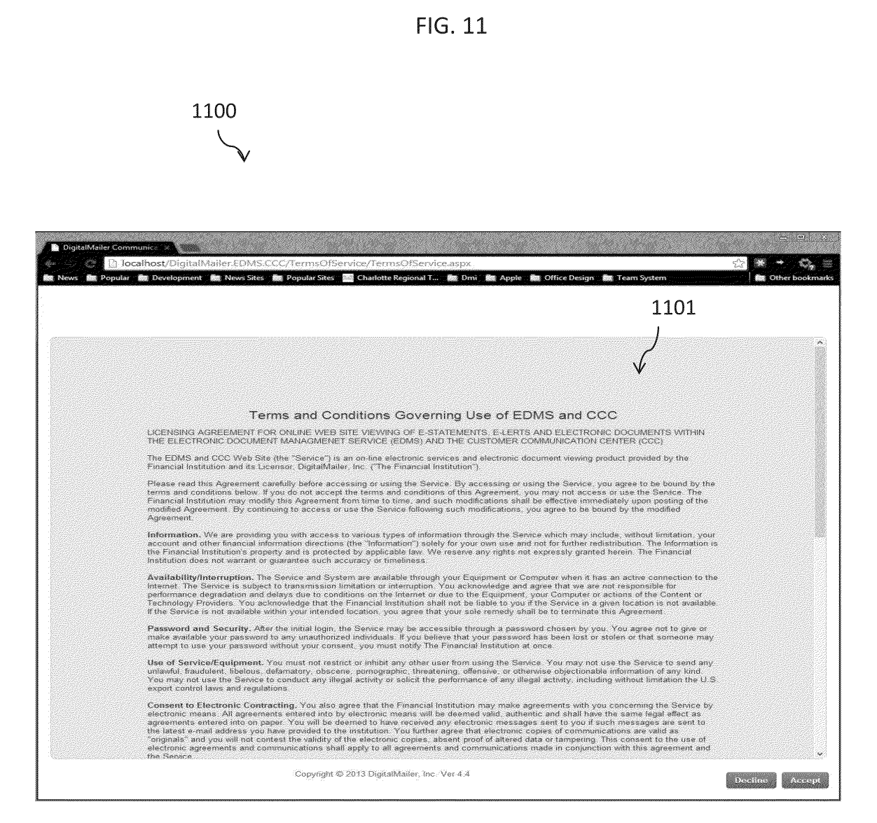

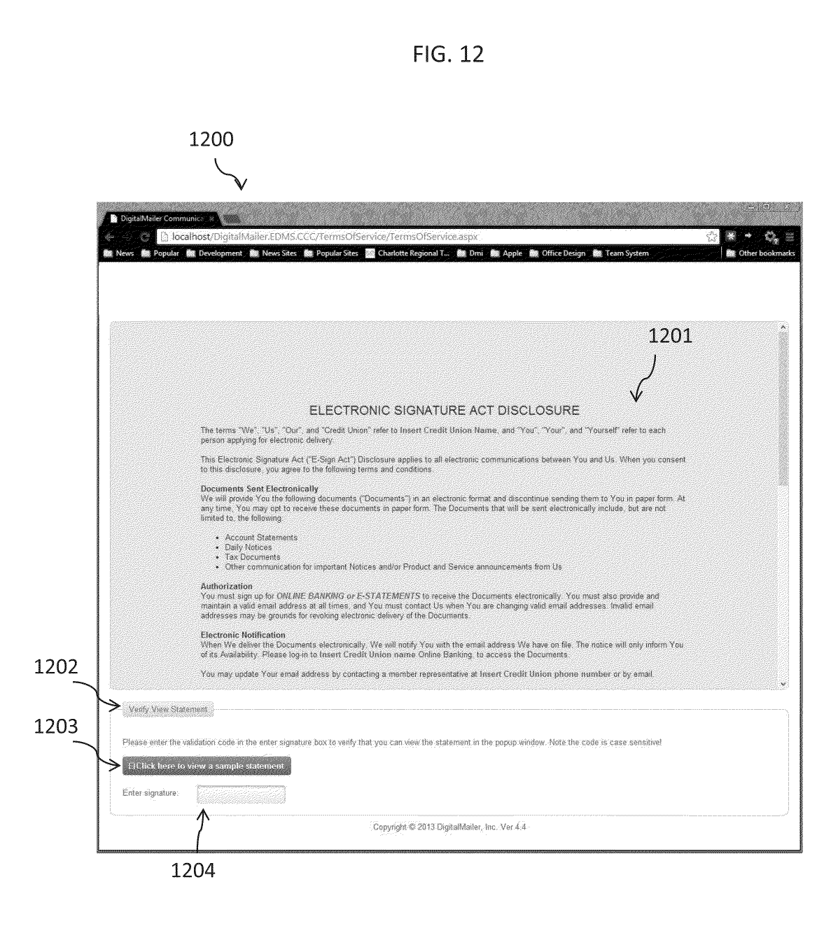

In method 300, an authorized party accesses the online banking system 100 to create a TOS agreement (as depicted in FIGS. 11 and 12).

At operation 302, upon accessing the online banking system 100, the authorized party generates a TOS agreement by first selecting a type of TOS agreement to be displayed. The TOS agreement may be a special compliance type of agreement (e.g., e-signature compliance) or a general TOS for displaying non-compliance terms. The present invention is not limited to any particular type of TOS agreement to be selected and may vary accordingly.

From operation 302, the process continues to operation 304, where upon selecting the type of TOS agreement to be displayed, identifier information associated with the type of TOS agreement is input by the authorized party. The identifier information may include, for example, a title of the terms to be displayed, and status information (active or inactive status).

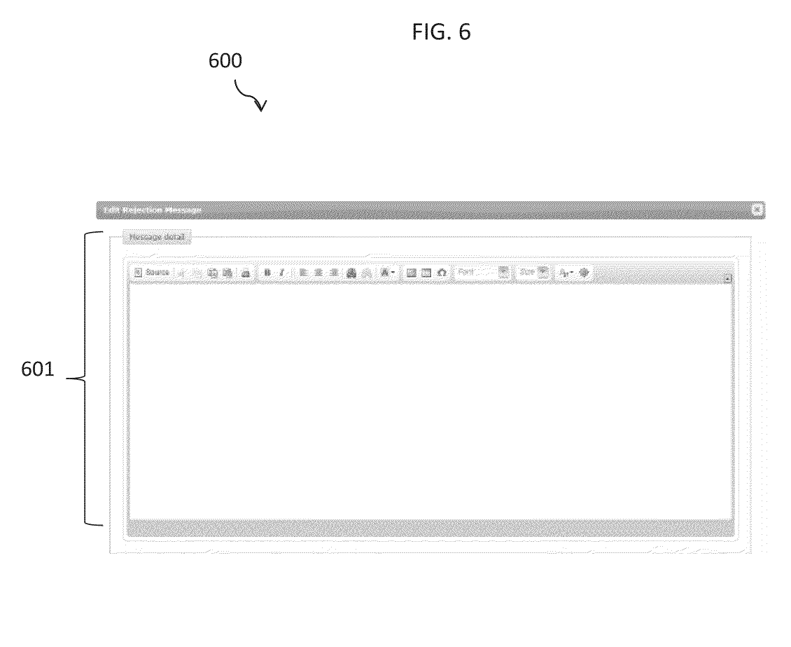

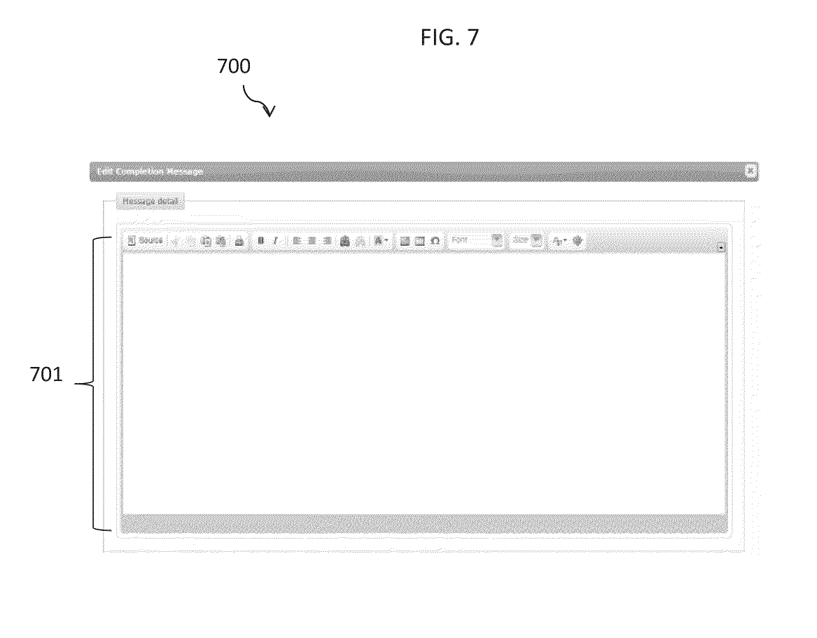

From operation 304, the process continues to operation 306 where one or more messages are created to be displayed to the user upon rejecting or accepting the TOS agreement. The one or more messages may include a rejection message created (as depicted in FIG. 6) and a completion message created (as depicted in FIG. 7). The present invention is not limited to any particular type of messages to be created for displaying to users of the online banking system 100, and may vary accordingly.

From operation 306, the process continues to operation 308 where the authorized party uploads an electronic document (e.g., a sample statement) to be displayed when performing the electronic document enrollment verification process. The authorized party may select an existing electronic document to be viewed or create a new electronic document to be viewed by the user for the verification process. The electronic document may be a document in any format (e.g., a portable document format or hypertext markup language format). The present invention is not limited to the electronic document being in any particular format. Upon generating of the TOS agreement, the TOS agreement may be stored as a default agreement to be displayed to users of the online banking system 100. The TOS agreement may be may be activated and deactivated as desired by the authorized party.

The present invention is described herein in terms of block components, screen shots, and optional selections and processing steps. It should be appreciated that the functional blocks may be realized by any number of hardware and/or software components configured to perform the specified functions. For example, the present invention may employ various integrated circuits e.g., memory elements, processing elements, logic elements, look-up tables, and others which may perform the functions under the control of one or more processors or other control devices. The software components can be implemented with any programming or scripting language, with various algorithms implemented with data structures, objects, processes, and other programming elements.

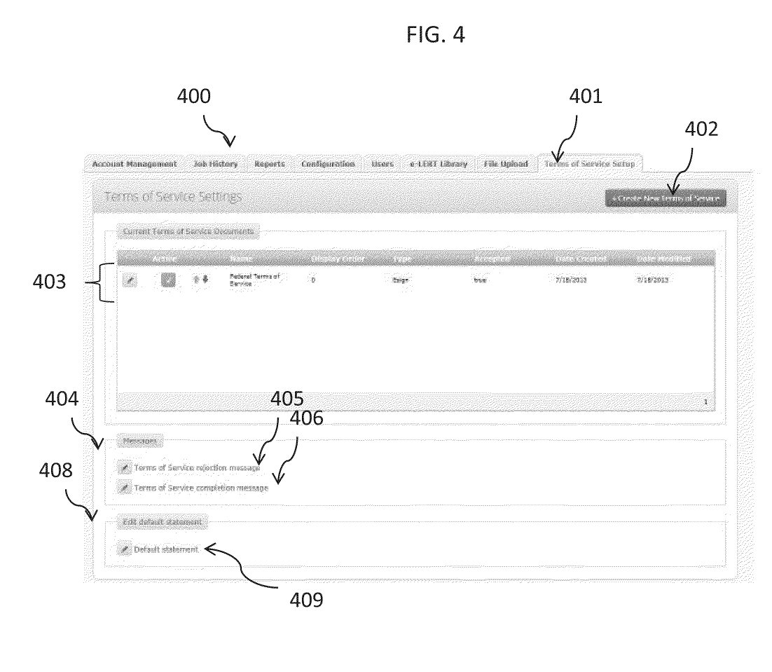

An exemplary process of the method 300 of FIG. 3 will be described with reference to the screen shots shown in FIGS. 4 through 9. Screen shots 400 through 900 shown in FIGS. 4 through 9, respectively, are implemented for example, via a web page for network transmission. The web page may include standard HTML documents, and various forms JAVA® applets, active server pages (ASP), common gateway interface scripts (CGI), extensive markup language (SML), dynamic HTML, plugins, etc.

As shown in FIG. 4, the screen shot 400 is provided. The screen shot 400 illustrates a plurality of options 401 to be displayed to the authorized party including account management, job history, reports, configuration, users, library, file upload, and TOS setup. Upon selecting the TOS setup option, the authorized party is able to create a TOS agreement and view existing TOS agreements 403 created. The authorized party is further able to view and create one or more messages 404 to be displayed to the user upon viewing of the TOS agreement. The messages 404 include a TOS rejection message 405 and a TOS completion message 406 to be displayed upon accepting or rejecting of the TOS agreement by a user of the online banking system 100.

The authorized party is also able to view and create a statement (e.g., a default statement 409) at the tab 408, to be displayed to the users.

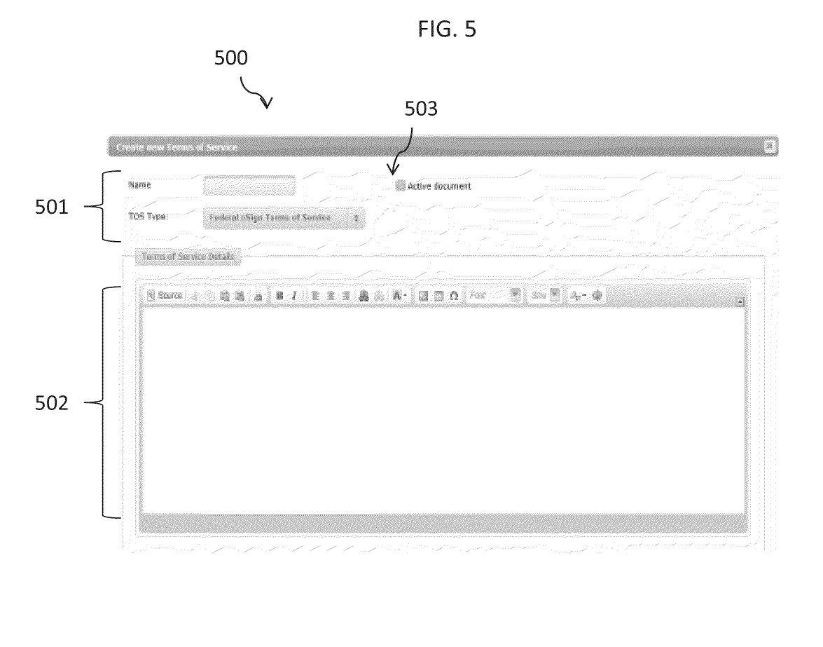

As shown in FIG. 5, a screen shot 500 is provided. The screen shot 500 includes identifier information 501 associated with the TOS agreement to be created. The identifier information 501 may include a name of the TOS agreement and type of TOS agreement (e.g., a special compliance agreement).

The screen shot 500 further includes an input section 502, for inputting the details of the TOS agreement and an active document option 503 for activating the TOS agreement.

As shown in FIG. 6, a screen shot 600 is provided. The screen shot 600 includes an input section 601 for inputting a rejection message to be displayed to the user upon rejecting of the TOS agreement by the user.

As shown in FIG. 7, a screen shot 700 is provided. The screen shot 700 includes an input section 701 for inputting a completion message to be displayed to the user upon completing and accepting of the TOS agreement by the user.

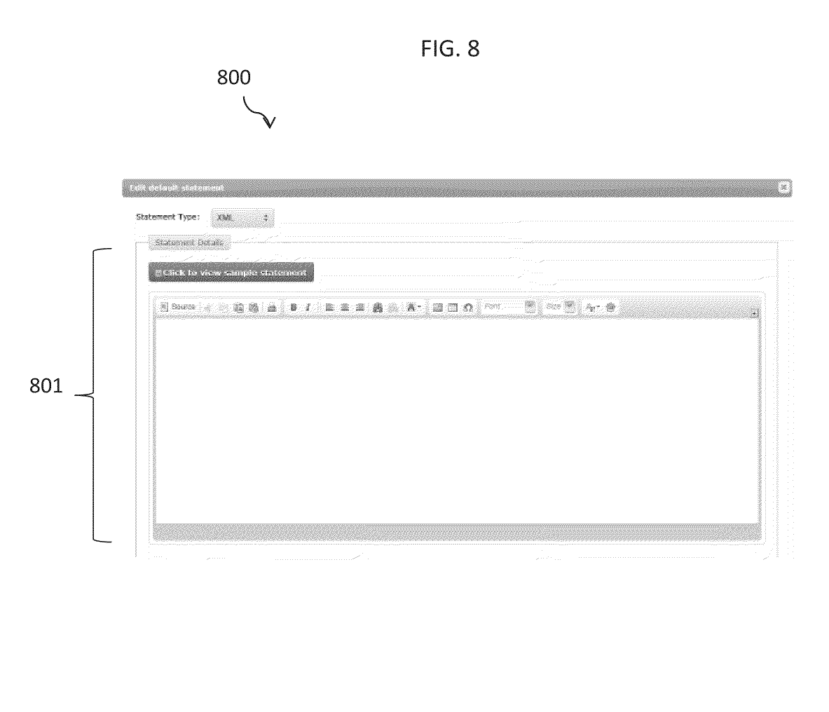

As shown in FIG. 8, a screen shot 800 is provided. The screen shot 800 includes an input section 801 for inputting a default statement to be included in the TOS agreement.

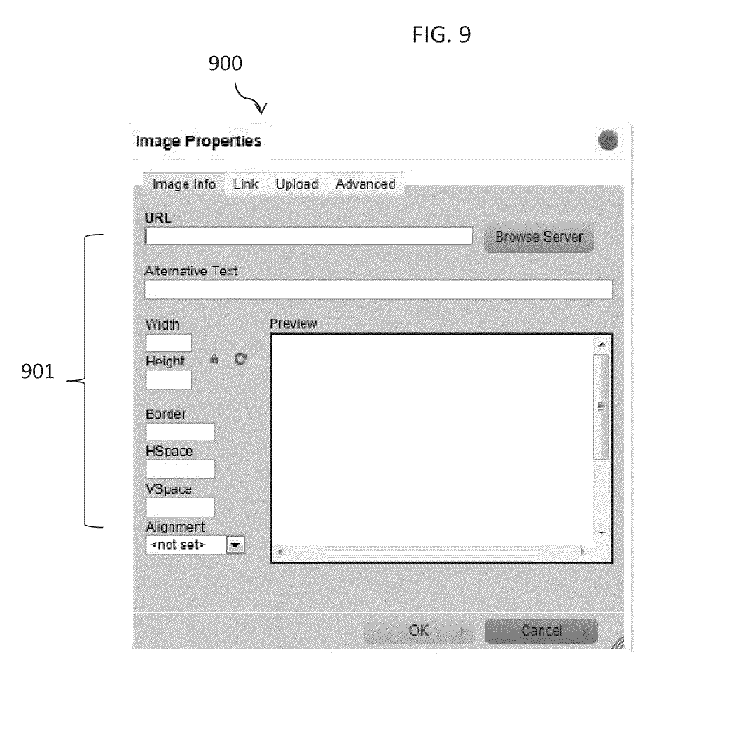

As shown in FIG. 9, a screen shot 900 is provided. The screen shot 900 includes image/document upload information for the electronic document to be viewed by the user during the electronic document enrollment verification process discussed above. The authorized party may input image information, a link or upload an electronic document.

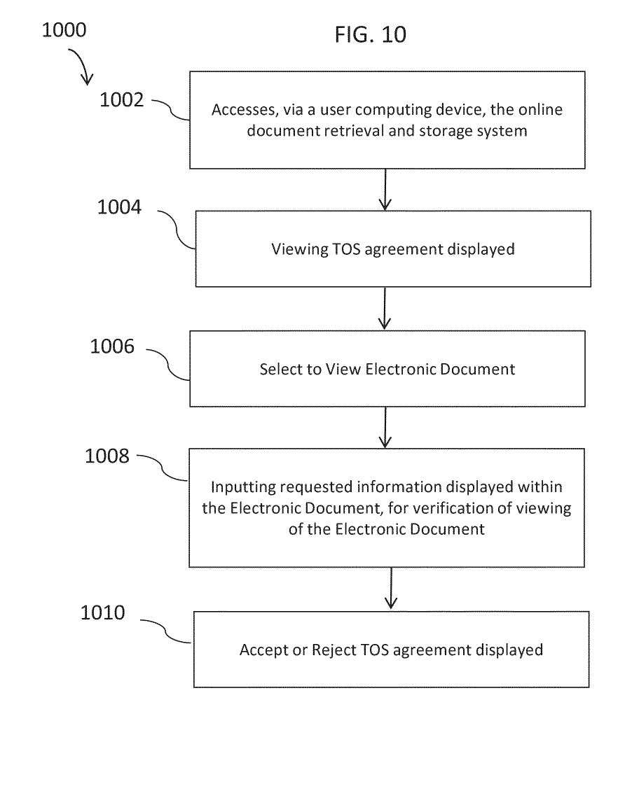

Once the TOS agreement is created it is stored and displayed to the users upon accessing the online banking system 100 as discussed below with reference to FIGS. 10 through 14.

FIG. 10 is a flowchart illustrating an electronic document enrollment verification method within a TOS agreement, to be implemented via the user computing device 50 upon accessing the online banking system 100. The method 1000 is implemented in software modules for execution by the user computing device 50 and the online banking system 100.

In method 1000, at operation 1002, the user is presented with a login window for performing a registration or login operation to access the online document retrieval and storage system (e.g., the online banking system 100). The user inputs access information (e.g., login information including email and password) as requested to gain access. At operation 1004, upon accessing the online banking system 100, a TOS may be displayed to the user for viewing.

From operation 1004, the process continues to operation 1006 where a user may be required to select to view an electronic document as a part of the electronic document enrollment verification process to determine that the user is able to receive and view documents electronically.

From operation 1006, the process continues to operation 1008 where the user inputs requested information displayed within the electronic document, for the verification process.

From operation 1008, the process continues to operation 1010, where the user accepts or rejects the TOS agreement displayed.

According to one or more embodiments, the user is required to accept the TOS agreement in order to gain access to the online banking system 100. That is, process prevents the user from accessing the system 100 until the user has accepted the TOS agreement including all terms of service.

An exemplary process of the method 1000 of FIG. 10 will be described with reference to the screen shots shown in FIGS. 11 through 14. Screen shots 1100 through 1400 shown in FIGS. 11 through 14, respectively, are implemented for example, via a web page for network transmission. The web page may include standard HTML documents, and various forms JAVA® applets, active server pages (ASP), common gateway interface scripts (CGI), extensive markup language (SML), dynamic HTML, plugins, etc.

As shown in FIG. 11, a screen shot 1100 including a TOS agreement 1101 created is provided for which a user is required to accept or reject.

In FIG. 12, screen shot 1200 illustrates an electronic document enrollment verification process 1201 within the TOS agreement to be performed by the user.

The process 1201 includes a description of the process, a verify view statement section 1202 which includes a view statement option 1203 and a input section 1204 for receiving information displayed within the electronic document (e.g., the statement) as evidence of proof of viewing of the electronic document.

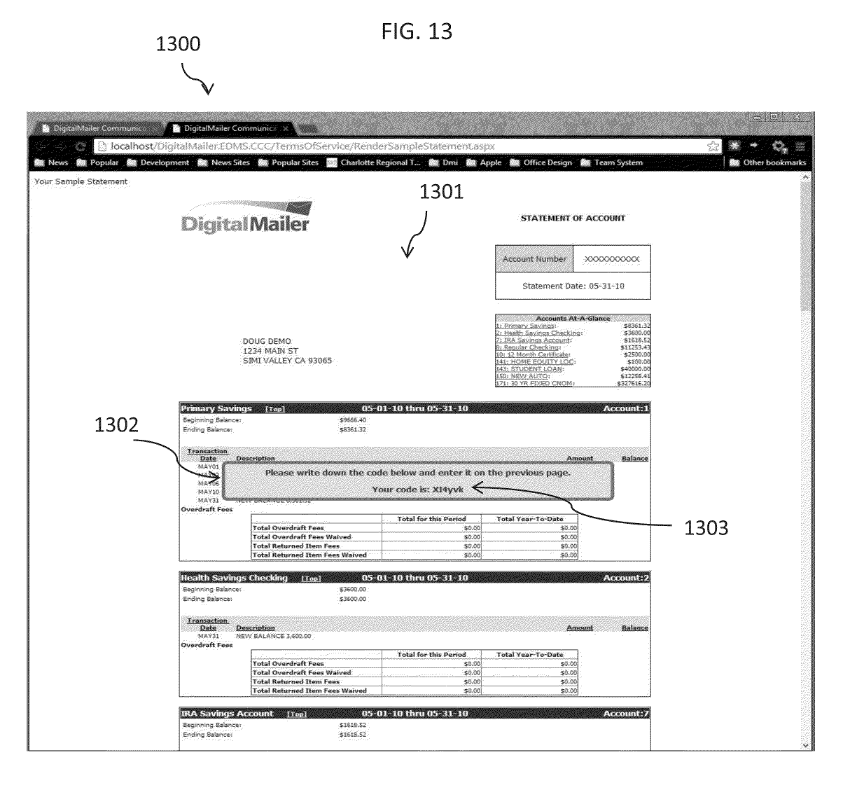

In FIG. 13, screen shot 1300 illustrates an electronic document (e.g., a sample statement 1301) to be viewed by the user upon selection of the view statement option 1203. According to one or more embodiments, the electronic document (i.e., the sample document) may be displayed to the user in different formats (e.g., a portable document format or hypertext markup language format). The present invention is not limited to the sample document being in any particular format, and may vary accordingly. As shown in the sample statement 1301, an information window 1302 is displayed and includes verification information 1303 (e.g., a verification code “X14yyk”).

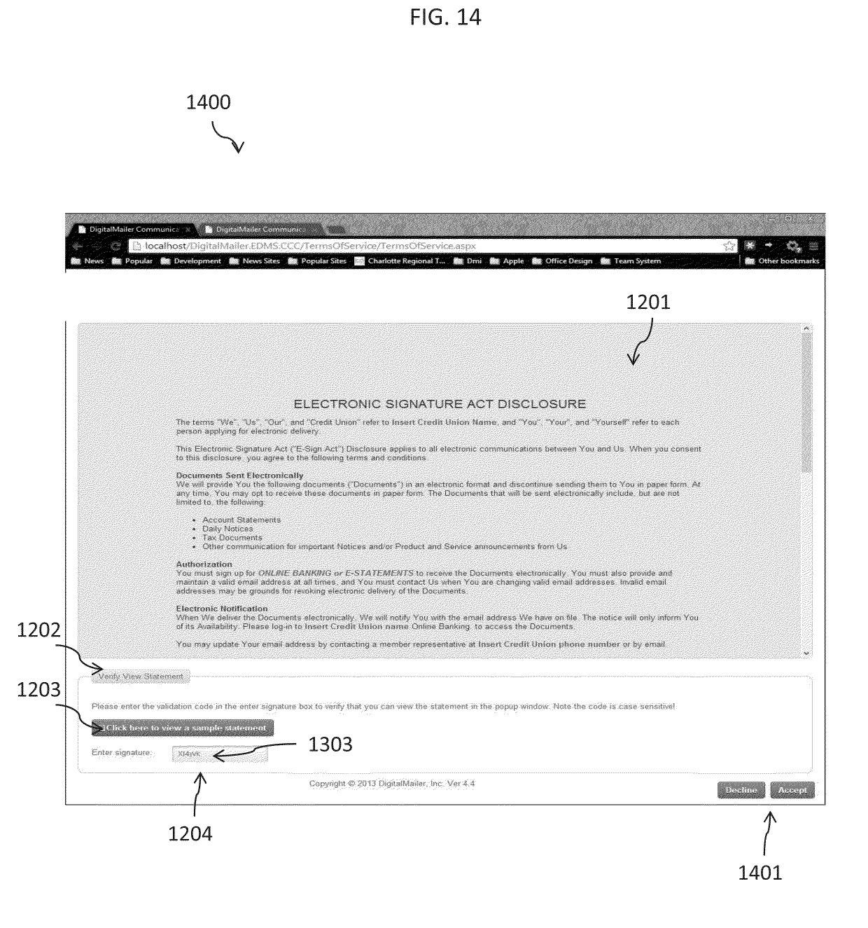

In FIG. 14, screen shot 1400 is provided. As shown, the user then inputs the verification information 1303 to complete the verification process. Upon inputting the verification information 1303, the user then selects whether to accept or decline the TOS agreement at option 1401. Once the user accepts the TOS agreement, is then able to access the online banking system 100 and receive documents electronically. A notification of acceptance or rejection of the TOS agreement may be stored within the online banking system 100 and associated with the user's account information.

According to one or more embodiments of the present invention, reports may be generated including a list of users that have accepted and rejected the TOS agreement for auditing or analysis purposes.

In view of the above, the present method embodiments may therefore take the form of a computer or controller implemented processes and apparatuses for practicing those processes. This disclosure can also be embodied in the form of computer program code containing instructions embodied in tangible media, such as floppy diskettes, CD ROMs, hard drives, or any other computer-readable storage medium, wherein, when the computer program code is loaded into and executed by a computer or controller, the computer becomes an apparatus for practicing the invention. This disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to implement the exemplary method described above.

According to one or more embodiments, the present invention provides a system comprising an online document retrieval and storage system in communication with a user computing device and configured to generate a terms of service (TOS) agreement including an electronic document to be viewed by a user at the user computing device; and the user computing device configured to display the TOS agreement, select and view the electronic document within the TOS agreement, wherein the electronic document comprises verification information therein to be viewed by the user, and receive the verification information as input by the user, for acceptance of the TOS agreement, wherein the online document retrieval and storage system receives a notification of acceptance of the TOS agreement via the user computing device.

According to one or more embodiments, the present invention provides a method implemented by computer system to effect the implementation of configuration of a terms of service (TOS) agreement within an online document retrieval and storage system. The method comprising selecting a type of TOS agreement to be displayed to the user; inputting identifier information associated with the type of TOS agreement; creating one or more messages to be viewed to the user upon accepting or rejecting the TOS agreement to be displayed; and uploading an electronic document within the TOS agreement, to be displayed during an electronic document enrollment verification process.

According to one or more embodiments, the present invention provides a method implemented by computer system to effect the implementation of performing an electronic document enrollment verification process within an online document retrieval and storage system using an user computing device in communication with the online document retrieval and storage system via a communication network. The method comprising accessing the online document retrieval and storage system; viewing a terms of service (TOS) agreement displayed via the user computing device; selecting to view an electronic document within the TOS agreement; inputting verification information displayed within the electronic document; and accepting or rejecting the TOS agreement displayed.

According to one or more embodiments, the present invention provides a computer readable medium storing computer executable instructions that, when executed, cause a computing device to perform configuration of a terms of service (TOS) agreement within an online document retrieval and storage system. The method comprising selecting a type of TOS agreement to be displayed to the user; inputting identifier information associated with the type of TOS agreement; creating one or more messages to be viewed to the user upon accepting or rejecting the TOS agreement to be displayed; and uploading an electronic document within the TOS agreement, to be displayed during an electronic document enrollment verification process.

According to one or more embodiments, the present invention provides a computer readable medium storing computer executable instructions that, when executed, cause a computing device to perform an electronic document enrollment verification process within an online document retrieval and storage system using an user computing device in communication with the online document retrieval and storage system via a communication network. The method comprising accessing the online document retrieval and storage system; viewing a terms of service (TOS) agreement displayed via the user computing device; selecting to view an electronic document within the TOS agreement; inputting verification information displayed within the electronic document; and accepting or rejecting the TOS agreement displayed.

While the invention has been described in terms of its preferred embodiments, it should be understood that numerous modifications may be made thereto without departing from the spirit and scope of the present invention. It is intended that all such modifications fall within the scope of the appended claims.

What is claimed is:

1. A system comprising:
an online document retrieval and storage system in communication with a user computing device and configured to:
generate a terms of service (TOS) agreement including an electronic document to be viewed by a user at the user computing device; and
the user computing device configured to:
display the TOS agreement,
select and view the electronic document within the TOS agreement, wherein the electronic document comprises verification information therein to be viewed by the user, and
receive the verification information as input by the user, for acceptance of the TOS agreement,
wherein the online document retrieval and storage system receives a notification of acceptance of the TOS agreement via the user computing device, and the user gains access to the online document retrieval and storage system upon receipt of the notification of acceptance.

2. The system of claim 1, wherein the user computing device comprises a web application for accessing the online document retrieval and storage system.

3. The system of claim 1, wherein the online document retrieval and storage system comprises an online banking system.

4. The system of claim 3, wherein the electronic document comprises a bank statement.

5. A method implemented by computer system to effect the implementation of configuration of a terms of service (TOS) agreement within an online document retrieval and storage system, the method comprising:
selecting a type of TOS agreement to be displayed to the user;
inputting identifier information associated with the type of TOS agreement;
creating one or more messages to be viewed to the user upon accepting or rejecting the TOS agreement to be displayed; and
uploading an electronic document within the TOS agreement, to be displayed during an electronic document enrollment verification process.

6. The method of claim 5, wherein the online document and retrieval storage system comprises an online banking system.

7. The method of claim 6, wherein the electronic document is a bank statement.

8. The method of claim 5, wherein the electronic document is in a portable document format or hypertext markup language format.

9. A computer readable medium storing computer executable instructions that, when executed, cause a computing device to perform configuration of a terms of service (TOS) agreement within an online document retrieval and storage system, the method comprising:
selecting a type of TOS agreement to be displayed to the user;
inputting identifier information associated with the type of TOS agreement;
creating one or more messages to be viewed to the user upon accepting or rejecting the TOS agreement to be displayed; and
uploading an electronic document within the TOS agreement, to be displayed during an electronic document enrollment verification process.

10. A method implemented by computer system to effect the implementation of performing an electronic document enrollment verification process within an online document retrieval and storage system using an user computing device in communication with the online document retrieval and storage system via a communication network, the method comprising:
accessing the online document retrieval and storage system;
viewing a terms of service (TOS) agreement displayed via the user computing device;
selecting to view an electronic document within the TOS agreement;
inputting verification information displayed within the electronic document; and
accepting or rejecting the TOS agreement displayed.

11. The method of claim 10, wherein the online document retrieval and storage system comprising an online banking system.

12. The method of claim 11, wherein the electronic document is a bank statement.

13. The method of claim 10, wherein the electronic document is in portable document format or hypertext markup language format.

14. A computer readable medium storing computer executable instructions that, when executed, cause a computing device to perform an electronic document enrollment verification process within an online document retrieval and storage system using an user computing device in communication with the online document retrieval and storage system via a communication network, the method comprising:
accessing the online document retrieval and storage system;
viewing a terms of service (TOS) agreement displayed via the user computing device;
selecting to view an electronic document within the TOS agreement;
inputting verification information displayed within the electronic document; and
accepting or rejecting the TOS agreement displayed.
